(19) United States
(12) Patent Application Publication
(10) Pub. No.: US 2015/0170402 A1
(43) Pub. Date: Jun. 18, 2015

(54) SPACE DIVISION METHOD, SPACE DIVISION DEVICE, AND SPACE DIVISION PROGRAM

(71) Applicant: FUJITSU LIMITED, Kawasaki-shi (JP)

(72) Inventors: Yui Noma, Kawasaki (JP); Makiko Konoshima, Yokohama (JP)

(21) Appl. No.: 14/532,404

(22) Filed: Nov. 4, 2014

(30) Foreign Application Priority Data
Dec. 17, 2013 (JP) 2013-260471

(51) Int. Cl. G06T 15/10

(52) U.S. Cl. CPC G06T 15/10

(57) ABSTRACT

With a search device according to the present embodiment, where an inverse stereographic projection unit performs an inverse stereographic projection of a feature vector onto a hyper-sphere divided into areas by a plurality of hyper-planes, and a bit string generating unit specifies a bit string on the basis of the results, a placement unit sets the initial positions of the hyper-planes. For example, the placement unit sets the initial positions of the hyper-planes so that the intersections of the hyper-planes are contained within the hyper-sphere.

### CROSS-REFERENCE TO RELATED APPLICATION(S)

This application is based upon and claims the benefit of priority of the prior Japanese Patent Application No. 2013-260471, filed on Dec. 17, 2013, the entire contents of which are incorporated herein by reference.

### FIELD

The embodiments discussed herein are directed to space division methods, etc.

### BACKGROUND

For example, when authenticating a user for various systems, a process is performed for obtaining biological information of the user and determining whether or not biological information that matches the obtained biological information exists in a pre-registered database. Now, a similarity search is effective because biological information obtained at the time of authentication hardly matches completely with the biological information obtained at the time of registration.

As to representation of the degree of similarity when performing a similarity search, there is a technique for converting feature values of biological information into a hash vector so that biological information for which the hamming distance between their hash vectors is short are specified as similar biological information.

With conventional techniques, feature values are converted into a hash vector by using a hyper-plane, but there are also processes where feature values are converted into a hash vector by using a hyper-sphere, and improvements to the precision can be better expected when a hyper-sphere is used.
Patent Literature 1: Japanese Laid-open Patent Publication No. 10-247243
Patent Literature 2: Japanese Laid-open Patent Publication No. 2012-160047
Patent Literature 3: Japanese Laid-open Patent Publication No. 2011-100395
Patent Literature 4: Japanese Laid-open Patent Publication No. 2010-81251
Patent Literature 5: Japanese Laid-open Patent Publication No. 2012-243197
Non Patent Literature 1: Jae-Pil Heo, Youngwoon Lee, Junfeng He, Shih-Fu Chang, and Sung-Eui Yoon. “Spherical hashing”, In CVPR, pp. 2957-2964, 2012.
Non Patent Literature 2: Kengo Terasawa and Yuzuru Tanaka. “Spherical lsh for approximate nearest neighbor search on unit hyper-sphere”, In Frank K. H. A. Dehne, Jorg-Rudiger Sack, and Norbert Zeh, editors, WADS, Vol. 4619 of Lecture Notes in Computer Science, pp. 27-38. Springer, 2007.

With conventional techniques, however, a similarity search using hash vectors are not performed with a high precision.

For example, when feature vectors are converted into hash vectors by using a hyper-sphere, there are cases where the hamming distance after the conversion into hash vectors may turn out to be small for feature vectors that are significantly different from each other, due to an influence of a worm hole. Therefore, different feature vectors may be determined erroneously as being similar feature vectors.

Now, a worm hole will be described. FIGS. 13 to 15 are diagrams illustrating a worm hole. For example, consider dividing an m-dimensional feature space V by using a hyper-sphere into areas, and assigning each area a bit string depending on whether the area is inside or outside the hyper-sphere. Depending on the placement of the hyper-sphere, area A and area B, not connected to each other, may have the same bit string (0,0,0), as illustrated in FIG. 13.

Where the phenomenon illustrated in FIG. 13 occurs, when one evaluates the similarity between feature vectors on the basis of the hamming distance between bit strings assigned to the feature vectors, the hamming distance may turn out to be small even if the feature vectors are significantly apart from each other. In order to understand this non-connectivity, one can assume a tube 10 connecting between area A and area B, as illustrated in FIG. 14. This tube is named “a worm hole” after a particular solution of general relativity.

FIG. 15 illustrates non-connected areas occurring when dividing one-dimensional feature space into areas by using the hyper-sphere S, and a worm hole 11 connecting between the areas. The hyper-sphere S is divided into areas by hyper-planes 12a and 12b. For example, an area on the left side of the hyper-plane 12a is assigned “1” in its first bit, and an area on the right side of the hyper-plane 12a is assigned “0” in its first bit. An area on the right side of the hyper-plane 12b is assigned “1” in its second bit, and an area on the left side of the hyper-plane 12b is assigned “0” in its second bit. Then, the vicinity of the south pole and the vicinity of the north pole of FIG. 15 are assigned the same bit string (0,0) even though they are not connected to each other. This is because of the worm hole 11 connecting between the vicinity of the south pole and the vicinity of the north pole of the hyper-sphere S.

### SUMMARY

According to an aspect of an embodiment, a space division method includes specifying an intersection position of a plurality of hyper-planes such that the intersection position is present within a sphere, when the plurality of hyper-planes are placed so as to divide the sphere present in a space of a dimension higher than a dimension of a feature space by one dimension or more; and initially placing the plurality of hyper-planes passing through the set intersection position.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIG. 1 is a functional block diagram illustrating a configuration of a search device according to the present embodiment.

FIG. 2 illustrates an example data structure of a feature value storage unit;

FIG. 3 illustrates an example data structure of a bit string storage unit;

FIG. 4 is a first diagram illustrating a relationship between a feature space V and a hyper-sphere S;

FIG. 5 is a second diagram illustrating a relationship between a feature space V and a hyper-sphere S;

FIG. 6 illustrates an example of an approximate straight line;

FIG. 7 is a diagram illustrating an example of a radius of a circular image obtained by a stereographic projection of the equator of the hyper-sphere S;

FIG. 8 is a flow chart illustrating a procedure of a search device according to the present embodiment;

FIG. 9 is a flow chart illustrating a procedure of a process of setting initial positions of hyper-planes;

FIG. 10 is a diagram illustrating an advantageous effect of a search device according to the present embodiment;

FIG. 11 is a flow chart illustrating a procedure of a process of setting other initial positions of hyper-planes;

FIG. 12 is a diagram illustrating an example computer executing a space division program;

FIG. 13 is a first diagram illustrating a worm hole;

FIG. 14 is a second diagram illustrating a worm hole; and

FIG. 15 is a third diagram illustrating a worm hole.

### DESCRIPTION OF EMBODIMENTS

Preferred embodiments of the present invention will be explained with reference to accompanying drawings. Note that the embodiments are not to limit the scope of the present invention.

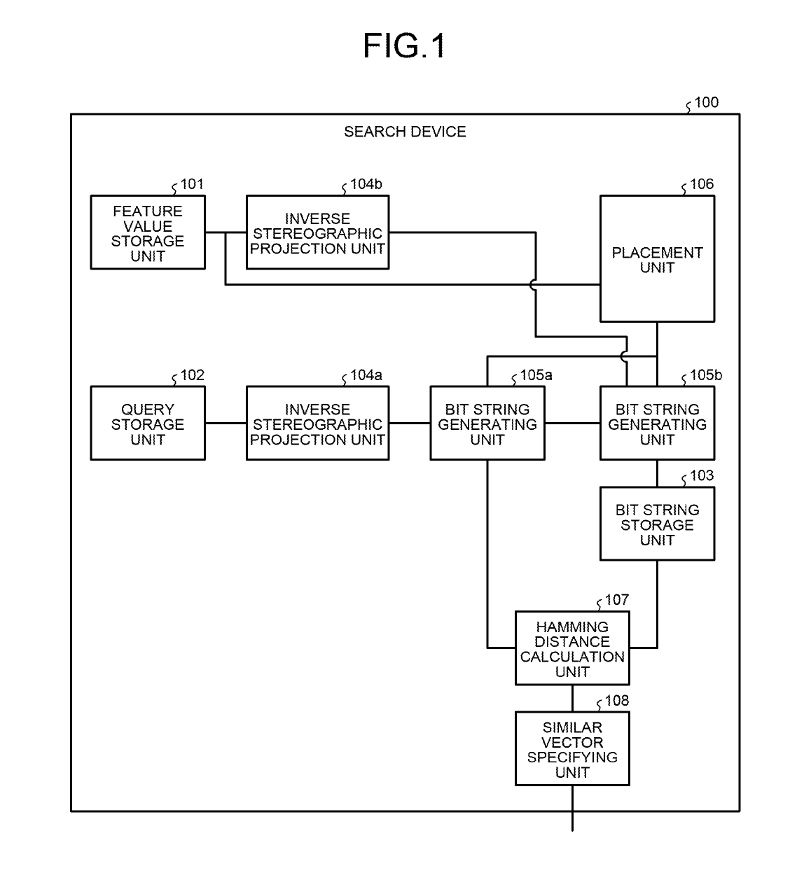

An example configuration of a search device according to Embodiment 1 will be described. The search device is an example of the space division device. FIG. 1 is a functional block diagram illustrating a configuration of a search device according to the present embodiment. As illustrated in FIG. 1, a search device 100 includes a feature value storage unit 101, a query storage unit 102, a bit string storage unit 103, inverse stereographic projection units 104a and 104b, and bit string generating units 105a and 105b. The search device 100 also includes a placement unit 106, a hamming distance calculation unit 107, and a similar vector specifying unit 108.

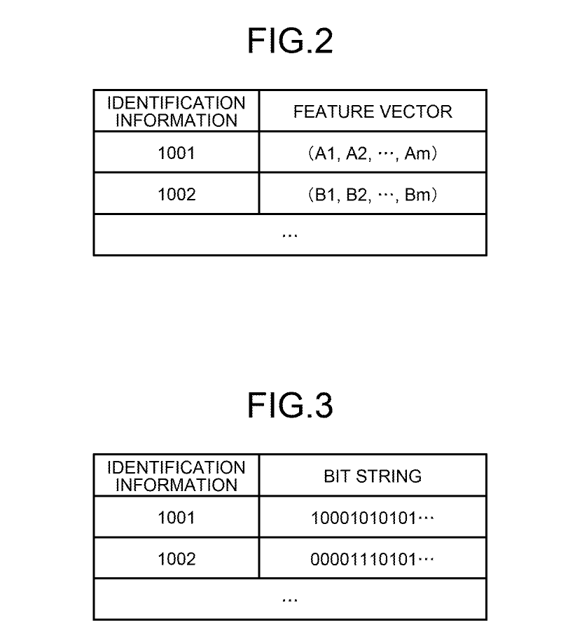

The feature value storage unit 101 is a storage unit for storing a plurality of feature vectors. FIG. 2 illustrates an example data structure of the feature value storage unit. As illustrated in FIG. 2, the feature value storage unit 101 stores identification information and feature vectors so that they are associated with each other. The identification information is information for uniquely specifying a feature vector. A feature vector is, for example, data of an m-dimensional feature value obtained from biological information of a user. Any of conventional techniques may be used as a method for obtaining a feature vector from biological information. For example, m is an integer of 1 or more.

The query storage unit 102 is a storage unit for storing a query feature vector. The search device 100 searches through the feature value storage unit 101 for a feature vector that is similar to the query feature vector.

The bit string storage unit 103 is a storage unit for storing bit strings obtained from a bit string generating unit 105 to be described later. FIG. 3 illustrates an example data structure of a bit string storage unit. As illustrated in FIG. 3, the bit string storage unit 103 stores identification information and bit strings so that they are associated with each other. The identification information is information for uniquely specifying the feature vector from which the bit string is generated. The bit string is a bit string that is generated on the basis of a feature vector.

The inverse stereographic projection units 104a and 104b are processing units for subjecting the m-dimensional feature space V to an inverse stereographic projection so that the feature space V is associated with the (m+p−1)-dimensional hyper-sphere S, which is embedded in a space W of which the number of dimensions is higher than m by p. Here, p is an integer of 1 or more. In the following description, the inverse stereographic projection units 104a and 104b may be referred to collectively as an inverse stereographic projection unit 104.

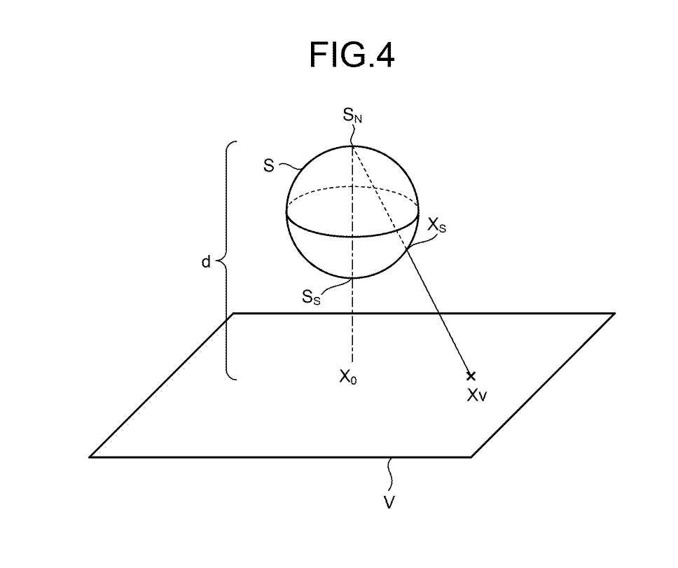

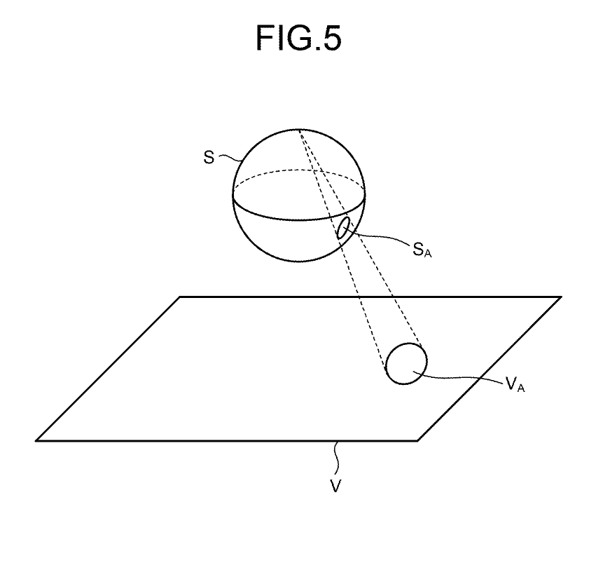

FIGS. 4 and 5 are diagrams each illustrating a relationship between the feature space V and the hyper-sphere S. Through an inverse stereographic projection, a point on the feature space V is associated with a point on the hyper-sphere S, as illustrated in FIG. 4. In the example illustrated in FIG. 4, a point x_{V} on the feature space V is associated with a point x_{S} on the hyper-sphere S. The intersection between the feature space V and the straight line extending between the north pole S_{N} and the south pole S_{S} of the hyper-sphere S is defined as x₀. For example, a set of coordinates for the north pole S_{N} is (x_{S1}, x_{S2}, . . . , x_{Sm}, 1), and a set of coordinates for the south pole is (x_{S1}, x_{S2}, . . . , x_{Sm}, −1).

The height from the feature space V to the north pole S_{N} of the hyper-sphere S is defined as d. The intersection between the straight line passing through the north pole S_{N} and the point x_{V} and the surface of the hyper-sphere S corresponds to x_{S}. For example, a cross section S_{A} of the hyper-sphere S corresponds to an area V_{A} of the feature space V, as illustrated in FIG. 5.

Now, an inverse stereographic projection is the inverse of a stereographic projection. Where the hyper-sphere S and the feature space V are arranged with a straight line extending from the north pole S_{N} to intersect with the hyper-sphere S, as illustrated in FIG. 4, a stereographic projection is defined as a mapping from the intersection x_{S} between the hyper-sphere S and the straight line onto the intersection x_{V} between the straight line and the feature space V. Note that the example illustrated in FIG. 4 represents a case where the value of p is 1.

It is assumed that where the feature vector (coordinate set) of the feature space V is (x₁, x₂, . . . , xₘ), the inverse stereographic projection “f⁻¹:V→U” is as expressed in Expression (1) below. Note however that r² in Expression (1) is defined as in Expression (2).

$$\begin{matrix}{f}^{- 1} ( {x}_{1} , … , {x}_{m} ) = ( \frac{2 d ( {x}_{1} - {x}_{o 1} )}{{d}^{2} + {r}^{2}} + {x}_{o 1} , … , \\ \frac{2 d ( {x}_{m} - {x}_{om} )}{{d}^{2} + {r}^{2}} + {x}_{om} , \frac{- {d}^{2} + {r}^{2}}{{d}^{2} + {r}^{2}} ) & ( 1 ) \\ {r}^{2} = {\sum }_{i = 1}^{m} {( {x}_{i} - {x}_{oi} )}^{2} & ( 2 )\end{matrix}$$

In Expressions (1) and (2), x₀ and d are parameters. The parameters x₀ and d correspond to x₀ and d illustrated in FIG. 4. The parameter x₀ is a coordinate of a point on the feature space V mapped onto the south pole S_{S} of the hyper-sphere S. The parameter d is a parameter for adjusting the scale of stereographic projection, and corresponds to the radius of the hyper-sphere S when the equator of the hyper-sphere S is mapped onto the feature space V. Note that a set of coordinates for the equator of the hyper-sphere S is (x_{S1}, x_{S2}, . . . , x_{Sm}, 0).

The inverse stereographic projection unit 104 performs an inverse stereographic projection of the feature vector on the basis of the specified parameters x₀ and d, and Expression (1). Note that the inverse stereographic projection unit 104 may have the information of the parameter x₀ and the parameter d pre-stored therein.

The inverse stereographic projection unit 104a performs an inverse stereographic projection on the basis of a feature vector stored in the query storage unit 102 and Expression (1), thereby calculating a set of coordinates on the hyper-sphere S corresponding to the feature vector. The inverse stereographic projection unit 104a outputs the calculated set of coordinates to the bit string generating unit 105a.

The inverse stereographic projection unit 104b performs an inverse stereographic projection on the basis of the feature vectors stored in the feature value storage unit 101 and Expression (1), thereby calculating a plurality of sets of coordinates on the hyper-sphere S corresponding to the respective feature vectors. The inverse stereographic projection unit 104b outputs the calculated sets of coordinates to the bit string generating unit 105b.

The bit string generating units 105a and 105b are processing units for converting a set of coordinates on the hyper-sphere S into a bit string in accordance with a conversion rule. The bit string corresponds to a hash vector. In the following description, the bit string generating units 105a and 105b may be referred to collectively as the bit string generating unit 105. The bit string generating unit 105 is an example of the generating unit.

In Expression (3), the information of the n×(m+1) matrix “W₁₁, W₁₂, . . . , Wₙ₍ₘ₊₁₎” and the information of n×1 “c₁, c₂, . . . , cₙ” are a conversion rule. The bit string generating unit 105 obtains the conversion rule from the placement unit 106 to be described later. In Expression (3), the information “x₁, x₂, . . . , xₘ₊₁” is a set of coordinates on the hyper-sphere S.

$$n ( [ \overbrace{\begin{matrix}{w}_{11} & {w}_{12} & {w}_{13} & {w}_{14} & … & {w}_{1 ( m + 1 )} \\ {w}_{21} & {w}_{22} & {w}_{23} & … & & \\ {w}_{31} & … & & & & \\ … & & & & & \\ {w}_{n 1} & & & & & {w}_{n ( m + 1 )}\end{matrix}}^{m + 1} ] [ \begin{matrix}{x}_{1} \\ {x}_{2} \\ ⋮ \\ {x}_{m} \\ {x}_{m + 1}\end{matrix} ] + [ \begin{matrix}{c}_{1} \\ {c}_{2} \\ ⋮ \\ \\ {c}_{n}\end{matrix} ] = [ \begin{matrix}{b}_{1} \\ {b}_{2} \\ ⋮ \\ \\ {b}_{n}\end{matrix} ] \qquad ( 3 )$$

The bit string generating unit 105 calculates “b₁, b₂, . . . , b₃, . . . , bₙ” by solving Expression (3). For example, the bit string generating unit 105 calculates b_{N} as illustrated in Expression (4) below.

b_{N}=(W_{N1}×x₁+W_{N2}×x₂+ . . . +W_{N,m+1}×xₘ₊₁)+c_{N} (4)

After calculating “b₁, b₂, b₃, . . . , bₙ,” the bit string generating unit 105 converts b_{N} to “1” if the value of b_{N} is positive and converts b_{N} to “0” if the value of b_{N} is not positive, thereby calculating a bit string. For example, where the values of “b₁, b₂, b₃, . . . , bₙ” are positive, negative, positive, . . . , positive, respectively, the bit string generating unit 105 generates a bit string “1, 0, 1, . . . , 1.”

The bit string generating unit 105a generates a bit string on the basis of a set of coordinates obtained from the inverse stereographic projection unit 104a, and outputs the generated bit string to the hamming distance calculation unit 107.

The bit string generating unit 105b generates a plurality of bit strings on the basis of sets of coordinates obtained from the inverse stereographic projection unit 104b, and outputs the generated bit strings to the bit string storage unit 103.

The placement unit 106 is a processing unit for placing, in the hyper-sphere S, n hyper-planes across the (m+p−1)-dimensional hyper-sphere S. The placement unit 106 also generates a conversion rule on the basis of the results of the placement. Hereinafter, the process by which the placement unit 106 specifies initial placements of the respective hyper-planes will be described, and then the process by which the placement unit 106 generates the conversion rule will be described.

The process by which the placement unit 106 specifies initial placements of the respective hyper-planes will now be described. The placement unit 106 obtains feature vectors from the feature value storage unit 101, and calculates the square root of the eigenvalue of the variance-covariance matrix for each feature vector. The placement unit 106 specifies, as a, the largest one of the eigenvalues. The placement unit 106 also defines the direction of the specified a as “vecN.”

The placement unit 106 calculates, as v, the third-order moment in the vecN direction. For example, the placement unit 106 calculates the third-order moment on the basis of Expression (5) below. In Expression (5), xᵢ^{(k)} corresponds to the i^{th} bit of the k-th feature vector, u corresponds to the average value of the feature vectors, and K corresponds to the number of the feature vectors.

$$v = \frac{1}{K} {\sum }_{k = 1}^{K} {\sum }_{i = 1}^{m} {( {vecN}_{i} \cdot ( {x}_{i}^{( k )} - {u}_{i} ) )}^{3} \qquad ( 5 )$$

Then, the placement unit 106 performs a principal component analysis on the feature vector, and calculates the cumulative contribution ratio. For example, the placement unit 106 performs a principal component analysis so as to obtain the spreads of the first to N^{th} principal components. The placement unit 106 arranges the spreads of the respective principal components in a descending order to denote the principal components as σ1, σ2, . . . , σN, starting from one with the largest spread. The placement unit 106 calculates λ on the basis of Expression (6) below. The placement unit 106 also calculates the cumulative contribution ratio λₘ on the basis of Expression (7) below.

$$\begin{matrix}λ = {\sum }_{i = 1}^{m} {σ}_{i} & ( 6 ) \\ {λ}_{n} = {\sum }_{i = 1}^{n} \frac{{σ}_{i}}{λ} & ( 7 )\end{matrix}$$

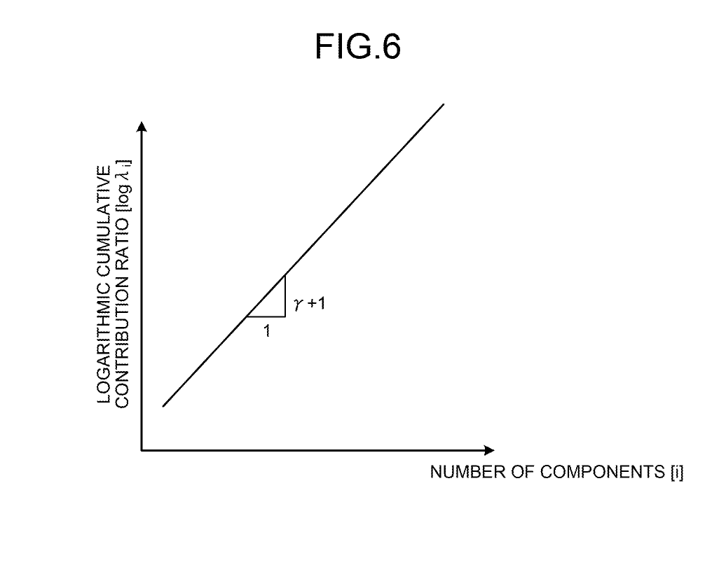

On a graph of which the horizontal axis represents the number “i” of components and the vertical axis represents the logarithmic cumulative contribution ratio “log λᵢ,” the placement unit 106 plots the relationship between i and log λᵢ, thereby specifying an approximate straight line from the results of plotting. For example, the placement unit 106 specifies the approximate straight line by using the least squares method, or the like. FIG. 6 illustrates an example of an approximate straight line. The placement unit 106 calculates while using “γ+1” as the gradient of the approximate straight line.

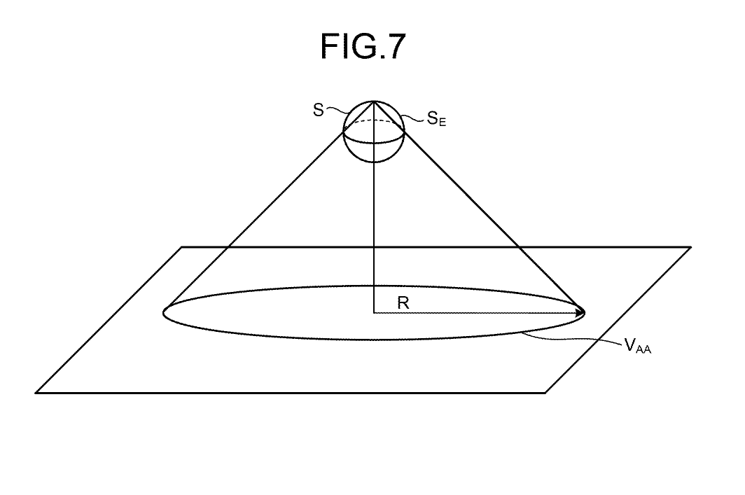

The placement unit 106 denotes, as R, the radius of a circular image obtained by a stereographic projection of the equator of the hyper-sphere S. FIG. 7 is a diagram illustrating an example of the radius of a circular image obtained by a stereographic projection of the equator of the hyper-sphere S. As illustrated in FIG. 7, the circular image obtained by a stereographic projection of the equator S_{E} of the hyper-sphere S is V_{AA}. Then, the radius of the circle V_{AA} is R.

The placement unit 106 calculates c1 on the basis of Expression (8), and c2 on the basis of Expression (9).

c1=(2/(1+exp(σ/((γ+1)R))))−1 (8)

c2=sgn(v)|v|^{1/3}/R (9)

The placement unit 106 sets the position of a common intersection among hyper-planes to be a position shifted from the center of the hyper-sphere S by c1 in the m+1-dimensional direction and by c2 in the vecN direction. The placement unit 106 also samples n normal vectors from the multi-dimensional standard normal distribution. The placement unit 106 sets, as an initial position, a hyper-plane having the sampled normal vectors and passing through the common intersection.

Next, the process by which the placement unit 106 generates the conversion rule will be described. The placement unit 106 generates information of the conversion rule on the basis of information of the normal vector of the hyper-plane and the offset amount of the hyper-plane. The placement unit 106 generates the information of the n×(m+1) matrix “W₁₁, W₁₂, . . . , Wₙ₍ₘ₊₁₎” by arranging the n normal vectors. For example, each row of the n×(m+1) matrix of Expression (3) corresponds to a normal vector. Note that the placement unit 106 assigns a random value to any missing dimension in the information of the n×(m+1) matrix. The placement unit 106 also generates offset coordinates as information of n×1.

The placement unit 106 outputs the information of the n×(m+1) matrix and the information of n×1 to the bit string generating unit 105.

The hamming distance calculation unit 107 is a processing unit for calculating the hamming distance between the bit string obtained from the bit string generating unit 105a and each of the bit strings stored in the bit string storage unit 103. A hamming distance obtained from a comparison between two binary values having the same number of digits is the number of digits for which the binary values differ from each other. In the following description, the bit string obtained from the bit string generating unit 105a is denoted as a query bit string.

The hamming distance calculation unit 107 outputs, to the similar vector specifying unit 108, the calculated hamming distance between the query bit string and each of the bit strings from the bit string storage unit 103.

The similar vector specifying unit 108 obtains the calculated hamming distances from the hamming distance calculation unit 107, and ranks the bit strings in an ascending order of the hamming distance with respect to the query bit string. The similar vector specifying unit 108 may output the highest-ranked bit string among the ranked bit strings as the bit string corresponding to the query bit string, or may output the ranking results.

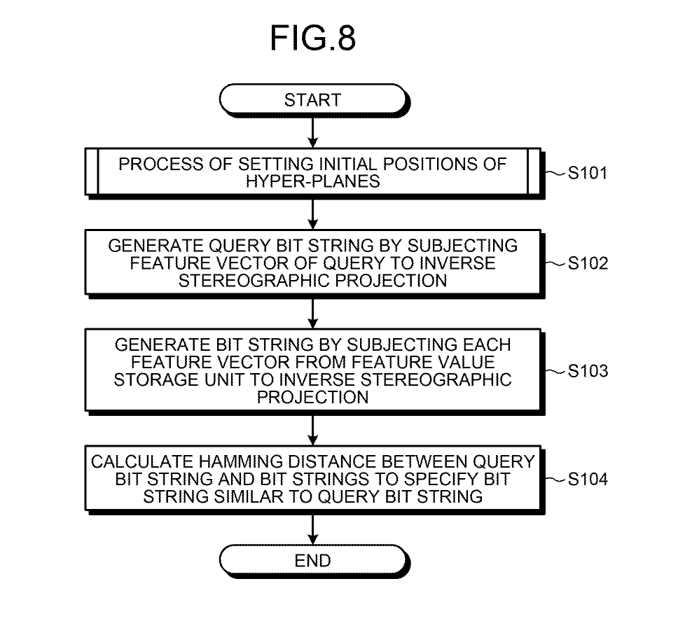

Next, an example procedure of the search device 100 according to the present embodiment will be described. FIG. 8 is a flow chart illustrating a procedure of a search device according to the present embodiment. The placement unit 106 of the search device 100 performs the process of setting initial positions of hyper-planes (step S101), as illustrated in FIG. 8.

The inverse stereographic projection unit 104a of the search device 100 subjects the feature vector of the query to an inverse stereographic projection, thereby generating the query bit string (step S102). The inverse stereographic projection unit 104b subjects feature vectors from the feature value storage unit 101 to an inverse stereographic projection, thereby generating bit strings (step S103).

The hamming distance calculation unit 107 of the search device 100 calculates the hamming distance between the query bit string and the bit strings from the bit string storage unit 103, and the similar vector specifying unit 108 specifies a bit string that is similar to the query bit string (step S104).

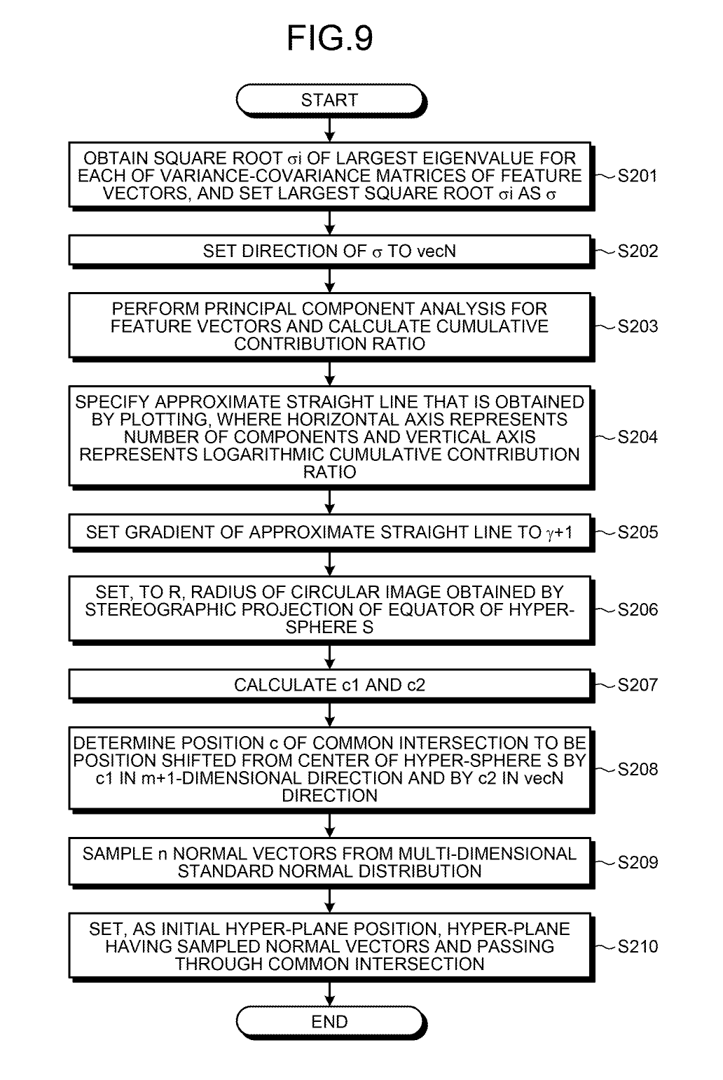

Next, the process of setting initial positions of hyper-planes in step S101 of FIG. 8 will be described. FIG. 9 is a flow chart illustrating a procedure of a process of setting initial positions of hyper-planes. The placement unit 106 obtains the square root σi of the largest eigenvalue for each of the variance-covariance matrices of the feature vectors, and sets the largest one of the square roots σi as σ, as illustrated in FIG. 9 (step S201).

The placement unit 106 sets the direction of σ to vecN (step S202). The placement unit 106 performs a principal component analysis for the feature vectors and calculates the cumulative contribution ratio (step S203). The placement unit 106 specifies an approximate straight line that is obtained as a result of plotting, where the horizontal axis represents the number of components and the vertical axis represents the logarithmic cumulative contribution ratio (step S204).

The placement unit 106 sets the gradient of the approximate straight line to γ+1 (step S205). The placement unit 106 sets, to R, the radius of a circular image obtained by a stereographic projection of the equator of the hyper-sphere S (step S206).

The placement unit 106 calculates c1 and c2 (step S207). For this step, the placement unit 106 calculates c1 and c2 on the basis of Expressions (8) and (9).

The placement unit 106 determines the position c of the common intersection to be a position shifted from the center of the hyper-sphere S by c1 in the m+1-dimensional direction and by c2 in the vecN direction (step S208).

The placement unit 106 samples n normal vectors from the multi-dimensional standard normal distribution (step S209). The placement unit 106 sets, as an initial hyper-plane position, a hyper-plane having the sampled normal vectors and passing through the common intersection (step S210).

Next, the advantageous effects of the search device 100 according to the present embodiment will be described. When specifying a bit string through an inverse stereographic projection of a feature vector onto a hyper-sphere divided into areas by a plurality of hyper-planes, the search device 100 sets the initial positions of the hyper-planes so that the intersections of the hyper-planes are contained within the hyper-sphere S. Thus, by setting the initial positions of the hyper-planes so that the intersections of the hyper-planes are contained within the hyper-sphere, it is possible to prevent the occurrence of a worm hole, thereby eliminating instances where the hamming distance after the conversion into hash vectors turns out to be small for feature vectors that are significantly different from each other. Therefore, with the search device 100, it is possible to perform a similarity search using feature vectors with a high precision.

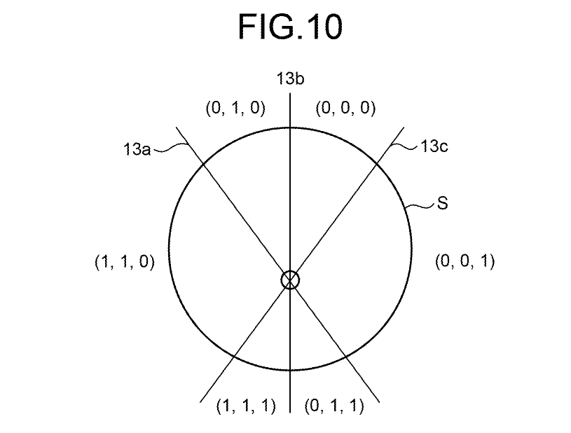

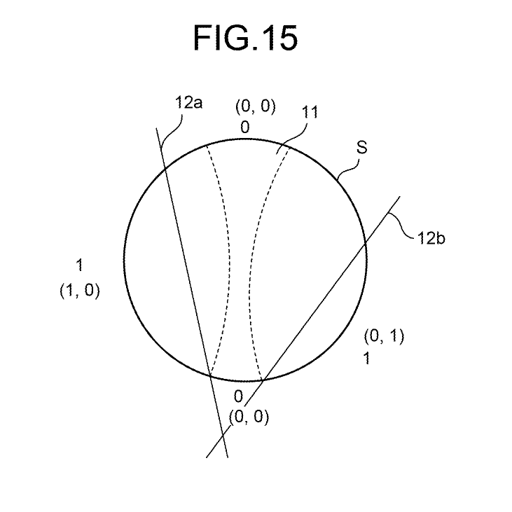

FIG. 10 is a diagram illustrating an advantageous effect of a search device according to the present embodiment. In the example illustrated in FIG. 10, the intersection between hyper-planes 13a, 13b and 13c is present within the hyper-sphere S. Thus, there is no worm hole, and it is possible to solve the problem where feature vectors that are significantly apart from each other may be assigned the same bit string, as illustrated in FIG. 15.

Now, the process by which the placement unit 106 sets the initial positions of hyper-planes is not limited to the process described above. Another process by which the placement unit 106 sets the initial positions of hyper-planes will be described below.

The placement unit 106 samples n normal vectors and offsets from the standard normal distribution, and determines the placement of the n hyper-planes on the basis of the sampled normal vectors and offsets. If an intersection for the n hyper-planes exists at the point at infinity, the placement unit 106 performs the sampling again to determine the placement of the n hyper-planes.

If the intersection is not present at the point at infinity for the n hyper-planes, the placement unit 106 determines whether or not the intersections are all present within the hyper-sphere S. If not all of the intersections are present within the hyper-sphere S, the placement unit 106 reduces in half the offsets of the n hyper-planes, and determines again whether or not the intersections are all present within the hyper-sphere S.

If the intersections are all present within the hyper-sphere S, the placement unit 106 specifies, as initial positions, the current positions of the hyper-planes.

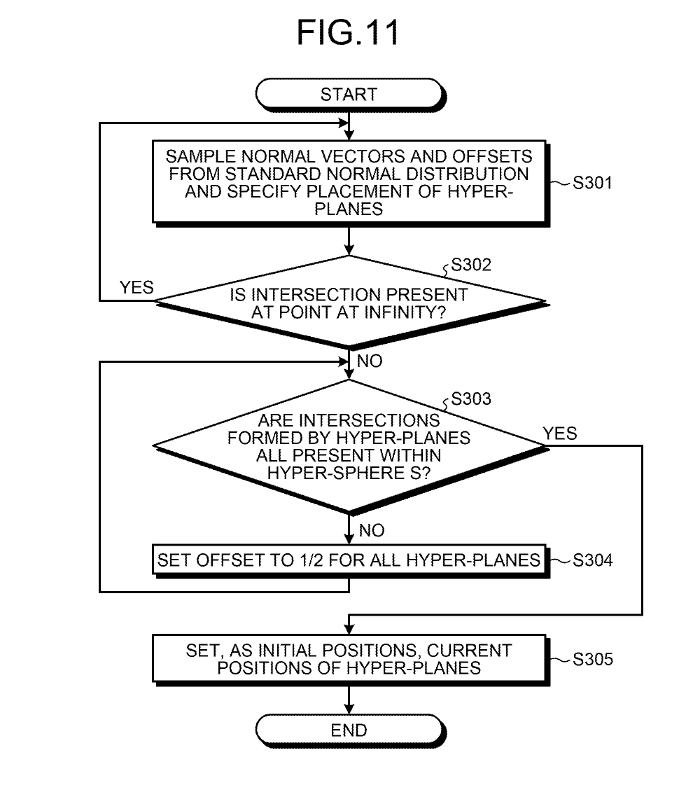

FIG. 11 is a flow chart illustrating a procedure of a process of setting other initial positions of hyper-planes. As illustrated in FIG. 11, the placement unit 106 samples normal vectors and offsets from the standard normal distribution, specifies the placement of the hyper-planes (step S301), and determines whether or not an intersection is present at the point at infinity (step S302). If an intersection is present at the point at infinity (Yes in step S302), the placement unit 106 proceeds to step S301.

On the other hand, if no intersection is present at the point at infinity (No in step S302), the placement unit 106 determines whether or not the intersections formed by the hyper-planes are all present within the hyper-sphere S (step S303). If not all of the intersections formed by the hyper-planes are present within the hyper-sphere S (No in step S303), the placement unit 106 reduces the offsets of all the hyper-planes to ½ (step S304), and proceeds to step S303.

On the other hand, if the intersections formed by the hyper-planes are all present within the hyper-sphere S (Yes step S303), the placement unit 106 sets, as initial positions, the current positions of the hyper-planes (step S305).

As the placement unit 106 specifies the initial positions of the hyper-planes as described above, the intersections of the hyper-planes are contained within the hyper-sphere S, and it is possible to prevent the occurrence of a worm hole, thereby eliminating instances where the hamming distance after the conversion into hash vectors turns out to be small for feature vectors that are significantly different from each other. Therefore, with the search device 100, it is possible to perform a similarity search using feature vectors with a high precision.

The embodiment described above is directed to a case where an inverse stereographic projection is performed on a hyper-sphere S that is present in the space of a dimension higher than the dimension of the feature space V by one dimension, but the present invention is not limited thereto. The present invention is similarly applicable to cases where an inverse stereographic projection is performed on an m-dimensional sphere that is present in the space of a dimension higher than the dimension of the feature space V by two or more dimensions, for example.

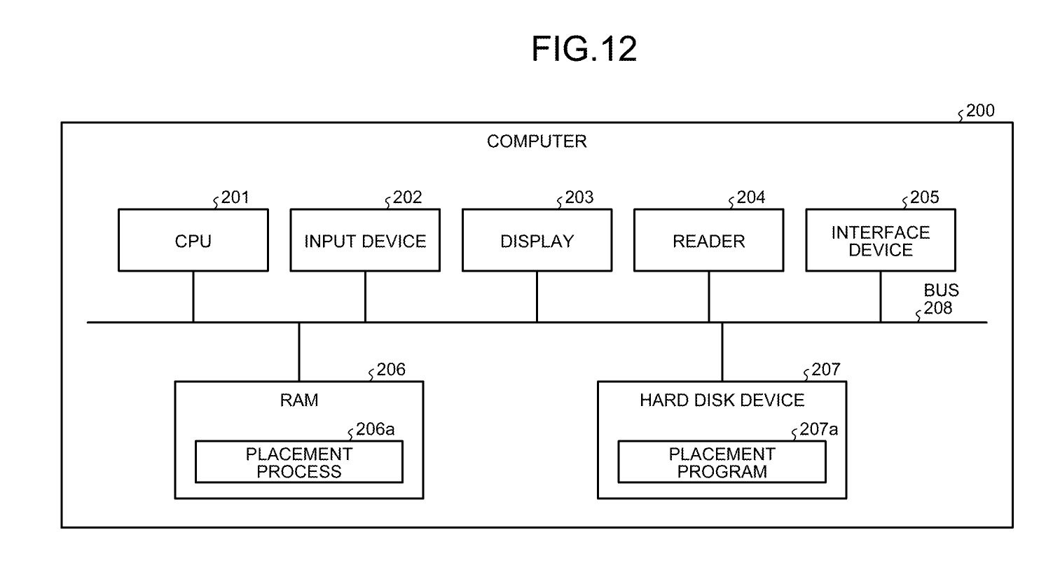

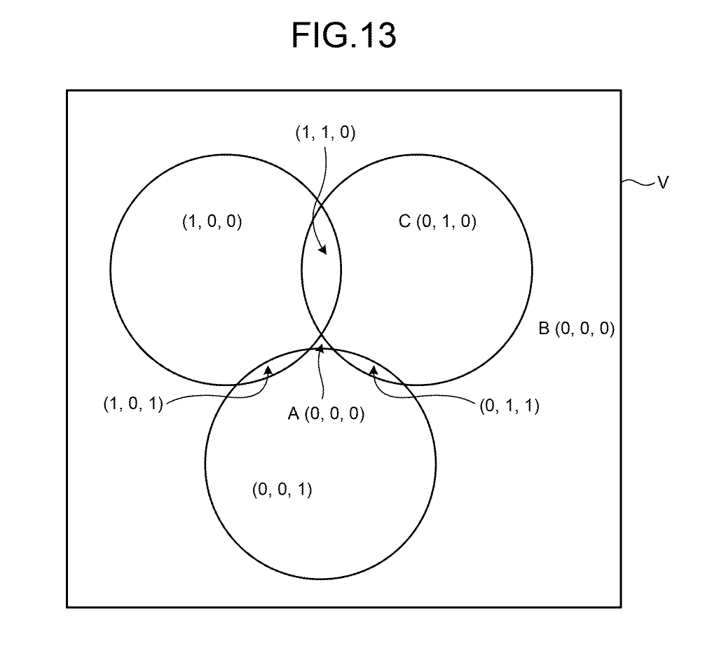

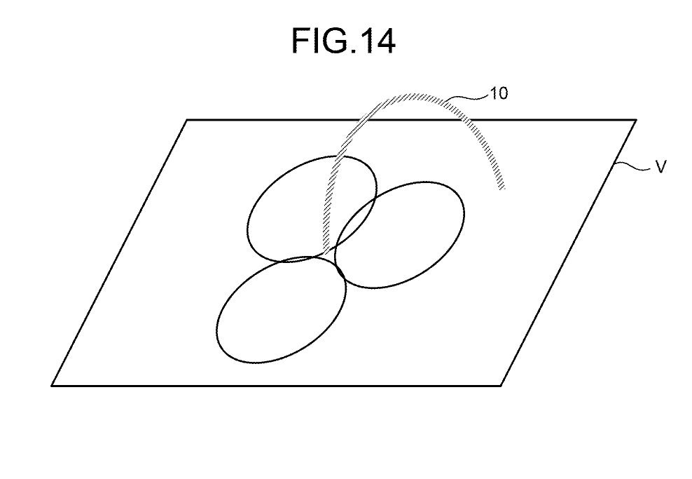

Next, an example computer will be described, which serves as an image processing device realizing similar functions to those of the search device 100 illustrated in the embodiment described above. FIG. 12 is a diagram illustrating an example computer executing a space division program.

As illustrated in FIG. 12, a computer 200 includes a CPU 201 for executing various arithmetic operations, an input device 202 for receiving data input from a user, and a display 203. The computer 200 also includes a reader 204 for reading a program from a storage medium, and an interface device 205 for exchanging data with other computers via a network. The computer 200 also includes a RAM 206 for temporarily storing various information, and a hard disk device 207. The devices 201 to 207 are connected to a bus 208.

The hard disk device 207 includes a placement program 207a. The CPU 201 reads out and extracts the program 207a onto the RAM 206. The placement program 207a functions as a placement process 206a. The placement process 206a corresponds to the placement unit 106, for example.

Note that the placement program 207a does not necessarily need to be stored in the hard disk device 207 in advance. For example, a program may be stored on a “portable physical medium”, such as a flexible disk (FD), a CD-ROM, a DVD disc, a magneto-optical disc, an IC card, etc., to be inserted into the computer 200. Then, the computer 200 may read out the placement program 207a therefrom, and execute the placement program 207a.

One embodiment of the present invention provides an advantageous effect of making it possible to perform a similarity search using feature vectors with a high precision.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A space division method to be performed by a computer, the method comprising:
specifying an intersection position of a plurality of hyper-planes such that the intersection position is present within a sphere, when the plurality of hyper-planes are placed so as to divide the sphere present in a space of a dimension higher than a dimension of a feature space by one dimension or more; and
initially placing the plurality of hyper-planes passing through the set intersection position.

2. The space division method according to claim 1, wherein the specifying process includes specifying a single point determined by a moment of a feature vector, the single point being equal to the intersection position.

3. The space division method according to claim 1, wherein the specifying process includes specifying the intersection position of the plurality of hyper-planes contained within the sphere by adjusting offset amounts of the plurality of hyper-planes.

4. A space division device comprising:
a processor configured to execute a process comprising:
specifying an intersection position of a plurality of hyper-planes such that the intersection position is present within a sphere, when the plurality of hyper-planes are placed so as to divide the sphere present in a space of a dimension higher than a dimension of a feature space by one dimension or more; and
initially placing the plurality of hyper-planes passing through the set intersection position.

5. The space division device according to claim 4, wherein the specifying process includes specifying a single point determined by a moment of a feature vector, the single point being equal to the intersection position.

6. The space division device according to claim 4, wherein the specifying process includes specifying the intersection position of the plurality of hyper-planes contained within the sphere by adjusting offset amounts of the plurality of hyper-planes.

7. A non-transitory computer-readable recording medium having stored therein a space division program for causing a computer to execute a process including:
specifying an intersection position of a plurality of hyper-planes such that the intersection position is present within a sphere, when the plurality of hyper-planes are placed so as to divide the sphere present in a space of a dimension higher than a dimension of a feature space by one dimension or more; and
initially placing the plurality of hyper-planes passing through the set intersection position.

8. The non-transitory computer-readable recording medium according to claim 7, wherein the specifying process includes specifying a single point determined by a moment of a feature vector, the single point being equal to the intersection position.

9. The non-transitory computer-readable recording medium according to claim 7, wherein the specifying process includes specifying the intersection position of the plurality of hyper-planes contained within the sphere by adjusting offset amounts of the plurality of hyper-planes.
